(19) United States
(12) Patent Application Publication
(10) Pub. No.: US 2006/0178269 A1
(43) Pub. Date: Aug. 10, 2006

(54) Plant conditioning treatment for plant growth and health enhancement

(76) Inventor: Luis R. Medina-Vega, Chihuahua (MX)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/052,293

(22) Filed: Feb. 8, 2005

(51) Int. Cl. A01N 63/00; A01N 43/54; A01N 37/00; A01N 37/10

(52) U.S. Cl. 504/117; 504/320; 504/321; 504/239; 504/240

(57) ABSTRACT

Compositions and methods are disclosed for encouraging vegetative and/or fruit growth in treated plants by a process that includes treating plant roots with a conditioning agent and inoculating the treated roots with a sufficient quantity of beneficial microorganisms to establish a colony of the beneficial microorganisms in and among the treated roots.

### FIELD OF THE INVENTION

The invention relates to compositions and methods for encouraging vegetative and/or fruit growth in treated plants and/or modifying the environment of the rhizosphere to induce an equilibrium in plant growth by a process including treating plant roots with a conditioning agent and inoculating the treated roots with a sufficient quantity of beneficial microorganisms to establish and grow a colony of the beneficial microorganisms among and in the roots of the treated plants.

### BACKGROUND OF THE INVENTION

There is a recognized link between the beneficial effects of certain soil microorganisms and the positive effects on growth of plants growing within or infected by a colony of such microorganisms. For example, U.S. Pat. No. 2,654,668 teaches a composition that contains plant hormones and a dry or degraded yeast as a source of vitamin compounds for plant growth. U.S. Pat. No. 5,262,381 teaches a method for infecting plants with a beneficial fungus (vesicular arbuscular mycorrhizal (VAM) fungi) by planting near a bait composition that encourages root growth into an infected inoculum so that the roots self-infect with the fungus. Published U.S. patent application Ser. No. 2003/0045428 teaches the use of a specific strain of B. laterosporus for infecting rice plants before rice before transfer to the paddy.

While many beneficial microorganisms have been identified, and many more remain to be discovered, there exists a need for a process that enhances the process of recognition, chemotaxys and sustainability of the beneficial microorganisms with the target plants.

### SUMMARY OF THE INVENTION

It is an objective of the present invention to provide a method for encouraging plant growth and vitality in desirable and/or commercially valuable plants.

It is a further objective of the invention to provide a method that also encourages infection and/or colonization of treated plants in a sustainable manner during the crop cycle with a colony of beneficial microorganisms in treated plants at high rates with enhanced vegetative and fruit yields.

The present invention relates to a system for conditioning plant roots with an organic root conditioning agent, and inoculating the conditioned plants with a microbiologic formulation comprising beneficial microorganisms. Preferably, this system is performed as a series of discrete and sequential steps separated by an adequate period of time to allow the conditioning agent to encourage root growth and make the root tissues amenable to infection and/or colonization at a rate sufficient to establish a sustainable colony of beneficial microorganisms with or around the plant roots. This combination of conditioning and infection allows the microorganisms to establish a more effective relationship with the plant physiology and results in adequate rhizosphere environment and enhanced vegetative growth, more roots, and higher fruit yields.

### DETAILED DESCRIPTION OF THE INVENTION

The present invention relates to a method for the enhancement of plant productivity and health by a treatment process including: (a) physiologically conditioning plant roots with a root conditioning agent, and (b) inoculating the treated roots with a microbiologic formulation comprising beneficial microorganisms in inactive or active colony form. This combination of conditioning and colonization forms a treatment system that encourages enhanced vegetative and fruit growth for greater yields and healthier plants. Healthier plants are more able to ward off environmental stresses, diseases, and pests which further enhances yield.

Plants and plant roots that can be conditioned according to the invention include virtually any living plant with roots. Such plants generally include grain crops, crops that grow fruiting sites, vegetables, grasses, flowers, trees, shrubs, and ornamental plants. Exemplary grain crops include corn, wheat, barley, rice, oat, rye. Other crops useful for treatment by the present invention include sesame, canola, beans, peas, chickpea, peach, almond, plum, prune, pecans, mango, avocado, papaya, banana, sugar beet, sugar cane, tobacco, agave, lettuce, cabbage, cauliflower, broccoli, carrot, radish, pepper, squash, pumpkin, artichoke, alfalfa, clover, and flowers (roses, carnations, chrysanthemum).

Examples of plants with fruiting sites include any of the raw agricultural commodity and especially cotton, soybeans, peanuts, grapes, apples, citrus (e.g., lemons, limes, oranges, grapefruit), berries (e.g., strawberries, blackberries, raspberries), tubers (e.g., potatoes, sweet potatoes), corn, cereal grains (e.g., wheat, rice, rye), tomatoes, onions, cucurbits (e.g., watermelon, cucumbers, and cantaloupes).

Suitable conditioning agents include organic compounds that enhance root growth. Examples of such materials include: (a) a polyhydroxycarboxylic acid, a hydroxybenzoic acid, and combinations of at least one polyhydroxycarboxylic acid and at least one hydroxybenzoic acid, such as those described in U.S. Pat. No. 5,525,576; (b) vitamins including Vitamin B sources such as thiamine, riboflavin, pyrodoxin, cyano-cobalamine, and Vitamin C sources including ascorbic acid; and panthotenic acid; (c) sugars including monosaccharides such as glucose, fructose, mannose, xylose, arabinose, lyxose, and galactose, disaccharides including sucrose, maltose, celobiose, oligosaccharides like raffinose, xylanes, galacturanes, ramnosanes, and glucanes; (d) polyols including myo-inositol, pinitol, glucitol, and galactitol; (e) organic aliphatic acids including hydroxyacetic, glutaric, ketoglutaric, malic, citric, succinic, adipic, gluconic, glucaric, and galactonic; (f) organic aromatic acids including hydroxybenzoic, cinnamic, ferulic, caffeic, chlorogenic, coumaric and salicylates; (g) ligno-derivatives including coniferol, sinapol, and coumarol; (h) flavones, flavanones and isoflavones such as luteolin, hesperitin, daidzein, and apigenin; (i) lipids including fatty acids such as lauric, myristic, palmitic, stearic, oleic, and linoleic, sterols such as sitosterol, stigmasterol, and campesterol; (j) carotenoids including β carotene, lycopene, and lutein; (k) amino acids such as leucine, lysine, aspartic acid, glutamic acid, asparagine, glutamine, cysteine, methionine, serine, threonine, proline, tryptophan, tyrosine, histidine, and phenylalanine; (l) puric and pirimidic bases like adenine, guanine, cytocine, and timine; (m) phyto-hormones including auxines such as indolbutiric acid, indolacetic acid, naphthalene acetic acid, indole-3-acetaldehyde, indole-3-acetamyde, indole-3-acetonitrile, indole-3-lactic acid, indole-3-propionic acid, indole-3-piruvic acid, indole-3-glycolic acid, 5-OH-tryptamine, 2,4-dichlorophenoxyacetic acid, benzo (selenienyl-3 acetic acid); (n) gibberellins including GA1, GA3, GA4; (o) cytokinins such as zeatin, zeatin riboside, kinetin, isopentenyladenine, dihydrozeatin, and benzyladenine; (p) other growth inducing or stimulating hormones such as triacontanol, brassinosteroids, polyamines, turgorins, and jasmonic acid, (q) humic acids, fulvic acids and humines, and (r) combinations of any of these.

Conditioning agents are generally applied at an application rate sufficient to enhanced growth of root tissues. Suitable application rates will depend on the specific treating agent, but will generally fall within the range from about 0.001 to 50 kg/hectare applied directly or indirectly to roots within the treatment area at a concentration range of 10⁻¹⁰ to 10⁻² M. The optimum application rate is, according to routine laboratory procedures, determined by routine screening at an escalating series of concentrations of a specific preconditioning agent, inoculating the treated roots at a specified rate of a beneficial microorganism, cultivating the inoculated roots under conditions suitable for colonization and growth of the microorganism, and measuring the size of the living microorganism colony within the treated roots. A simple graph of the results should be sufficient to establish a working approximation of the optimum conditioning agent concentration.

Plant roots should be treated at a stage in the plant's growth cycle in which the application is performed before transplanting or in green house, at sowing or at transplanting and during the growth cycle with intervals of one and two weeks or monthly for trees. Application of the present treatment is desirably performed at transplanting to flowering and during fruit, tuber, bulbs and head filling.

Following the preconditioning treatment, the treated roots is inoculated directly or indirectly with a microbiologic formulation comprising an inactive or active colony of microorganisms that are beneficial for treated plant due to their bioprevention, biostimulation, soil conditioning, bioremedial, or competitive herbicidal effects. The specific form used for inoculation will depend on the specific type of beneficial microorganism but should present a stable concentration when packaged by the manufacturer through application at suitable inoculation rates. Suitable formulations may include a microorganism in a dry form or an aqueous solution. Aqueous solutions can also be used in which the microorganisms are in an inactive form due to the presence or absence of a triggering component whose removal or addition causes the microorganism to become active in situ, e.g., an acidic or basic pH that causes the microorganism to form spores in storage but which is later neutralized after application so the microorganism colony becomes vegetative in situ.

Suitable beneficial microorganisms for use in the present invention include plant growth promoting rhizobacteria (PGPR) and other type of bacterial rhizospherics such as Pseudomonas sp., Bacillus sp., Azotobacter sp., Azospirillum sp., Rhizobium sp., Bradyrhizobium sp., Agrobacterium sp., Enterobacter sp., Paenibacillus sp., Burkholderia sp., Methylobacter sp., Pantoea sp., Pasteuria sp., Anabaena sp., and Nostoc sp. Also useful are beneficial fungi including Trichoderma, vesicular arbuscular mycorrhizal; Actinomycete: Streptomyces sp., Micromonospora sp., Streptosporangium sp., Actinomadura sp., Microtetrasporas sp., Nocardia sp., Saccharopolyspora sp., Streptoverticillium sp., Microbispora sp., Microtetraspora sp., Actinobispora sp., Thermoactinomyces sp., Actinoplanes sp., and Gordonia sp.

The specific application rate for each microorganism will depend on the microorganism, its dilution, minimum density for colonization, temperature, soil pH, and presence of antagonistic microorganisms present in the treated soil around the preconditioned plant roots. In general, suitable concentrations are within the range from about 10²-10¹² CFU/g or CFU/mL.

### EXAMPLES

### Example 1

Sod pieces of creeping bentgrass sold under the “Penncross” product name were collected from field plots and transplanted into clear plastic bags (5-cm diameter and 40 cm long) filled with fine sand. Plants were sprayed with a product called Nutrisorb™ containing an extract made according to U.S. Pat. No. 5,525,576 that contains polyhydroxycarboxylic acids and other hydroxybenzoic acids, in five rates immediately following transplanting and then weekly for four weeks:

a) 0 (water control)

b) 0.5 gallon per acre (low dose)

c) 1.0 gallon per acre (moderate dose)

d) 2 gallon per acre (high dose)

Those plants were grown at a daily maximum and minimum temperature of 20 and 15° C. During the sod establishment period, plants were irrigated daily. Turf was mowed daily at 4 mm height with an electric clipper.

This experiment mainly examined whether the compound could promote sod establishment by stimulating root growth. Turf quality was rated based on color, density, and uniformity using a scale of 0 (brown, dry turf) to 9 (green, turgid turf), with a rating of 6.0 or higher indicating acceptable quality. Maximum rooting depth, root number per pot and root dry weight were measured at 2, and 4 weeks of treatment. Each treatment had four replicates.

TABLE 1
Turf quality during sod establishment at
2 and 4 weeks after Nutrisorb treatment.

Treatments

| | Nutrisorb | Nutrisorb | Nutrisorb | |
|---|---|---|---|---|
| Evaluation | High | Med | Low | Control |
| At 2 weeks | 7.7 a | 7.5 a | 7.5 a | 6.4 b |
| At 4 weeks | 8.3 a | 8.4 a | 8.3 a | 7.2 b |

TABLE 2
Rooting depth (mm) during sod establishment
at 2 and 4 weeks after Nutrisorb treatment.

Treatments

| | Nutrisorb | Nutrisorb | Nutrisorb | |
|---|---|---|---|---|
| Evaluation | High | Med | Low | Control |
| At 2 weeks | 108 ab | 112 a | 123 a | 85 b |
| At 4 weeks | 224 a | 203 ab | 210 ab | 182 b |

TABLE 3
Rooting dry weight (mg/plot) during sod establishment
at 2 and 4 weeks after Nutrisorb treatment.

| | Treatments | | | | |
|---|---|---|---|---|---|
| | | Nutrisorb | Nutrisorb | Nutrisorb | |
| Evaluation | | High | Med | Low | Control |

| | | | | | | | |
|---|---|---|---|---|---|---|---|
| At 2 weeks | 57 | ab | 79 | a | 83 | a | 53 b |
| At 4 weeks | 112 | a | 110 | a | 114 | a | 83 b |

TABLE 4
Root number during sod establishment at
2 and 4 weeks after Nutrisorb treatment.

| | Treatments | | | | |
|---|---|---|---|---|---|
| | | Nutrisorb | Nutrisorb | Nutrisorb | |
| Evaluation | | High | Med | Low | Control |

| | | | | | | | | |
|---|---|---|---|---|---|---|---|---|
| At 2 weeks | 19 | bc | 38 | a | 24 | b | 13 | c |
| At 4 weeks | 27 | c | 45 | b | 61 | a | 47 | b |

The application of Nutrisorb™ at all doses increased turf quality during the 4-week period of transplanting, compared to the control treated with water (Table 1). Low and medium doses of Nutrisorb™ increased rooting depth at 2 week of treatment and the high dose of Nutrisorb™ had positive effects at 4 week of treatment (Table 2). Root dry weight was increased with the application of medium and high dose of Nutrisorb™ at 2 weeks of application and all doses had positive effects at 4 week of treatment (Table. 3). Low and medium doses of Nutrisorb™ increased root number at 2 week of treatment and the low dose of Nutrisorb™ had positive effects at 4 week of treatment (Table 4).

The data from this example establishes the effects on plant growth of polyhydroxycarboxylic acids combined with hydroxybenzoic acids.

### Example 2

Tomato plants were grown in culture solution in 1 L containers, one for each plant. The solution was refilled daily to the original position in the bottle. At 14 days after transplant the treatments were initiated:

1) Control: Plants were sprayed with water

2) Root-zone injection, low dose: Nutrisorb was applied into the nutrient solution at 0.5 gallon per acre rate per application. There were two applications per week during first two weeks.

3) Root-zone injection, medium dose: Nutrisorb was applied into the nutrient solution at 1.0 gallon per acre rate per application. There were two applications per week during first two weeks

4) Root-zone injection, high dose: Nutrisorb was applied into the nutrient solution at 2.0 gallon per acre rate per application. There were two applications per week during first two weeks.

At 18 days after treatment initiation electrical conductivity of culture solutions were measured. There were four plants per treatment as four replicates. Treatments were randomly placed in the greenhouse.

Electrical conductivity of the culture solution decreased at medium and high doses of Nutrisorb™ treatments, indicating more rapid nutrient uptake from the solution by the treated plants than control plants (table 5).

TABLE 5
Electrical conductivity (mmhos/cm) of the culture solution
at 18 days after Nutrisorb ™ treatment.

| | Treatments | | | |
|---|---|---|---|---|
| | Nutrisorb ™ | Nutrisorb ™ | Nutrisorb ™ | |
| | High | Med | Low | Control |
| Conductivity at | 2.77 | 2.89 | 3.1 | 3.05 |
| 18 days after | | | | |
| treatment | | | | |

### Example 3

Tomato plants were established from seeds and grown in a greenhouse in nutrient solution culture in plastic bottles. The solution was refilled daily to the original position in bottle. Ten days after seed germination, three treatments were imposed:

1) Control: Plants were sprayed with water.

2) Foliar application: Nutrisorb was applied by foliar spray at one gallon per acre rate application. There were two applications per week during first two weeks.

3) Root-zone injection: Nutrisorb™ was applied into the nutrient solution at 1 gallon per acre rate per application. There were two applications per week during first two weeks.

There were four plants per treatment as four replicates. Treatments were randomly placed in the greenhouse. Plants were labeled with ¹⁴CO₂ at the 7^{th} day after the last application of Nutrisorb™. Plants were enclosed in a clear, plexiglass chamber and exposed to ¹⁴CO₂ for one hour between 11:00 to 14:00 on sunny day. ¹⁴CO₂ was generated from the reaction of Na H₂ ¹⁴CO₃ and lactic acid. The amount of ¹⁴CO₂ labeled photosynthates allocated into leaves, roots, and the culture medium (exudates) were measured at 72 hrs after labeling. The amount of 14-C exuded into the culture solution was significantly (p=0.05) higher in plants treated with Nutrisorb™ by applying into the culture solution than untreated control (Table 6), and that may have affected nutrient uptake.

TABLE 6
14-C activity in exudates (counts per
minute) at 72 hrs after labeling.

| | Treatments | | |
|---|---|---|---|
| | Nutrisorb ™ in | Nutrisorb ™ foliar | |
| | culture solution | application | Control |
| Counts/Minute | 18.5 a | 13.0 b | 9.5 b |

### Example 4

In a green house indeterminate tomato plants were established in 12 L pots with sand as a substrate. The plants were grown to production stage with nutrient solution feeding according to nutrient demand in every phenologic stage.

A minirhizotron technique was used to evaluate the dynamics of root growth, by taking root images with a video camera introduced in transparent polybutyrate tubes 2 inches in diameter which were previously inserted into the root zone of the substrate. Images were digitalized and processed with a software program which quantifies the number of active roots, the length and the superficial area of the roots. Each image shows a sampled area of 238 mm² and 72 images per tube (per plant) are analyzed. The sampling for root growth study was carried out at 30, 60, 90 and 120 days after transplanting.

Exuroot™, a product containing polyhydroxycarboxylic acids under U.S. Pat. Nos. 5,525,576 and 5,352,264 was injected into the substrate at a dose of 1 qt/acre per application at 0, 8, 15, 22, 28, 43, 73, 88 and 103 days after transplanting. There were 10 plants per treatment as 10 replicates. Treatments were randomly placed in the greenhouse. A control was carried with only nutrient application.

All variables evaluated showed similar results with a strong root growth from 30 to 60 days after transplanting and medium growth from 60 to 90 and from 90 to 120 days after transplanting. The Exuroot™ treatment was significantly higher as compared to control in number of roots, length and superficial area of roots at 30 and 120 days after transplanting which occurred at the critical stages of growth initiation and cutting, when struggle exists for photosynthates between the roots and the fruits. (Tables 7, 8, and 9.)

TABLE 7
Number of roots [#/dm²(soil)] active during the growing
stage of tomato plants after treatment with Exuroot ™.

Days after transplanting

| Treatment | 30 | 60 | 90 | 120 |
|---|---|---|---|---|
| Control | 23 | 221 | 284 | 338 |
| Exuroot | 36 | 220 | 272 | 482 |

TABLE 8
Root length [cm/dm²(soil)] during the growing stage
of tomato plants after treatment with Exuroot ™.

Days after transplanting

| Treatment | 30 | 60 | 90 | 120 |
|---|---|---|---|---|
| Control | 18.9 | 146.4 | 194.6 | 245.5 |
| Exuroot | 26.4 | 158.0 | 195.5 | 338.4 |

TABLE 9
Superficial area of roots [cm²/dm² (soil)] during the growing
stage of tomato plants after treatment with Exuroot ™.

Days after transplanting

| Treatment | 30 | 60 | 90 | 120 |
|---|---|---|---|---|
| Control | 1.98 | 10.96 | 16.05 | 21.8 |
| Exuroot | 2.46 | 13.61 | 17.95 | 31.78 |

### Example 5

The trial was established with indeterminate tomato plants, variety Attention, on a clay-sandy soil, in simple rows with a distance of 1.8 meters. A conditioning and microbiologic cultivation treatment process according to the invention are performed by injecting the components into drip irrigation system as follows:

(a) Exuroot™ applications were made weekly during the first 5 weeks at 2 L/Ha per application and then every 2 weeks up to the end of the cycle, at 1 L/Ha per application.

(b) Applications of a commercially available formulation sold under the RHIZOBAC™ name by CHEMPORT INC, containing Bacillus subtilis, B. Licheniformis, B. megaterium and Pseudomonas aureofaciens in a concentration of 1×10⁸ CFU/mL. Applications were made weekly at 8 L/Ha per application during the first 5 weeks and then applications were made every 2 weeks at the same dose.

The parameters evaluated in this example included:

(a) Root activity and growth: Immediately after transplanting 5 minirhizotron tubes were installed in each treatment. Sixty images were taken per tube on each sampling date every 40 days initiating at transplanting. The images were analyzed with the software “RootTracker” to obtain total number of active roots, root length and superficial area in each observation tube.

(b) Microorganisms Population Dynamics: Samples were taken of rhizospheric microorganisms population at 3 and 5 months after transplanting in 5 plants per treatment. Plate counting was performed of the main groups of microorganisms.

(c) Nutrient uptake: The plants taken for population determination in the second sampling were used for the evaluation of nutrient uptake; after measuring dry weight of roots, stems and fruits, a complete nutrient determination was performed extrapolating the data to Kg/Ha.

(d) Yield and quality: Data were taken from product packing of the different sizes of each treatment, during the entire harvest period.

(e) Incidence of root rot. An evaluation was made at the end of the experiment by counting the number of plants with symptoms of damage by Fusaruim oxysporum as a function of total plants in 5 sampling sites.

With respect to root growth, at first and second samplings, no significant differences were shown between treatments in root growth and activity. In the third and fourth samplings the plants treated with the system of the invention showed a higher number of roots as compared to control. In the fourth sampling, treated plants showed 60% higher root length and 50% higher superficial root area, as compared to control (Table 10).

TABLE 10
Effect in root growth dynamics of tomato plants
after treatment with system of invention

| | Number of | | | | Superficial area | |
|---|---|---|---|---|---|---|
| | roots/dm² | | Length cm/dm² | | cm²/dm² | |
| Sampling | Control | Treated | Control | Treated | Control | Treated |
| 40 dat | 36 | 40 | 24.15 | 26.1 | 26.32 | 23.45 |
| 80 dat | 83 | 69 | 21.64 | 18.99 | 21.43 | 18.36 |
| 120 dat | 63 | 98 | 39.09 | 56.68 | 29.67 | 42.23 |
| 140 dat | 87 | 110 | 45.09 | 68.9 | 32.67 | 46.42 |

dat = days after transplanting

Regarding microorganism population, the system of the invention increased rhizospheric microorganisms population by ten times or more. This result confirms the effect of the system of the invention not only on the rhizobacteria applied but also on the native microorganisms, creating a healthy root environment (Table 11).

TABLE 11
Effect on the dynamics of rhizospheric microorganisms population
after the application of the system of invention in tomato plants

| | Aerobic bacteria | | Actinomycetes | | Pseudomonads | |
|---|---|---|---|---|---|---|
| | (cfu/g) | | (cfu/g) | | (cfu/g) | |
| Sampling | Control | Treated | Control | Treated | Control | Treated |
| 90 dat | 5.4 × 10⁶ | 7.4 × 10⁷ | 1.7 × 10⁵ | 3.1 × 10⁶ | 2 × 10⁵ | 4.3 × 10⁶ |
| 150 dat | 6.5 × 10⁶ | 5.6 × 10⁷ | 5.5 × 10⁵ | 1.3 × 10⁶ | 5 × 10³ | 4.8 × 10⁵ |

dat = days after transplanting

Nutrient uptake per hectare was calculated on the basis of nutrient content in the plant, mean dry weight of the plant and plant population density. The treatment with the system of the invention showed an increase in total nutrient uptake (N, P, K, Ca and Mg) by 49% as compared to control. The most significant effect was shown for calcium and magnesium with almost 100% increase; a lower increase but non the less very important was shown for potassium.

TABLE 12
Effect on nutrient uptake after the application
of System of invention in tomato plants

| | Nutrient (Kg/Ha) | | | | |
|---|---|---|---|---|---|
| Treatment | N | P | K | Ca | Mg |
| Control | 380 | 41 | 303 | 455 | 61 |
| Treatment | 411 | 53 | 397 | 841 | 167 |

The yield of first quality fruits showed an increase of 20.2% as compared to control with a tendency to increase the differences with every cut, except the last month when the yield increase was lower.

TABLE 13
Effect on first quality yield after the application
of system of invention in first class tomato plants

| | Yield (Boxes/Ha) | | | | |
|---|---|---|---|---|---|
| Treatment | 1^{st}. month | 2^{nd}. Month | 3^{rd} month | 4^{th} month | Total |
| Control | 933 | 2947 | 1689 | 1374 | 6943 |
| Treatment | 1100 | 3215 | 2492 | 1544 | 8351 |

At the end of the crop cycle root rot tendency was evaluated the main cause agent being Fusarium oxysporum. Plants were counted starting at symptom appearance and up to the death of the plant. The control showed an incidence of 20% as compared to 8% for the treatment.

### Example 6

In this example, yellow indeterminate bell pepper, cv Taranto, in green house management and with sandy loam soil were used. The peppers were planted in a double row with a distance of 1.85 m between rows.

Treatments according to the invention were injected in the dripping irrigation system as follows:

a. Exuroot™: During the first 5 weeks Exuroot was applied at 2 L/Ha per week and after that, every two weeks at a dose of 1 L/Ha per application up to the end of the crop cycle.

b. Rhizobac-P™: This product was applied during the first 5 weeks at 8 L/ Ha per week and after that, applications were carried every two weeks at the same dose.

Population samplings were taken at 2 and 4 months after transplanting in five plants per treatment. The population was determined by plate counting of the main groups of microorganisms. The plants taken for population counting at the second sampling were used for the determination of root, stems, leaves and fruits dry weights. Total nutrient content was also determined and calculated as kg/Ha. Yield and quality were taken from the packing of the production per treatment of the different sizes during all cutting stages.

Results showed that the system of the invention increased rhizospheric microorganisms from 2 to 10 times as much as the control. These results confirm the positive effects of the invention on rhizosphere microbiota by creating a healthy root environment (Table 14).

TABLE 14
Effect of the application of Exuroot ™ plus a formulation of Bacillus
and Pseudomonas on the dynamics of rhizospheric microbiota population
in bell pepper

| | Aerobic bacteria | | Actinomycete | | Pseudomonads | |
|---|---|---|---|---|---|---|
| | (cfu/g) | | (cfu/g) | | (cfu/g) | |
| Sampling | Control | Treatment | Control | Treatment | Control | Treatment |
| 60 dat | 3.1 × 10⁶ | 2 × 10⁷ | 9.3 × 10⁴ | 9 × 10⁵ | 1.1 × 10⁶ | 4.1 × 10⁶ |
| 120 dat | 6.4 × 10⁶ | 3.8 × 10⁷ | 1.7 × 10³ | 1.8 × 10⁴ | 5.5 × 10⁵ | 1 × 10⁶ |

After nutrient content and mean dry weight were determined for each plant and considering the plant population density, nutrient uptake was calculated per hectare. The treatment of the invention showed an increase in total nutrient uptake (N, P, K, Ca and Mg) of 32.8% as compared to control. The most significant effect was shown for nitrogen with almost 50% increase , followed by phosphorus and potassium with 35% and 30% increases, respectively, as compared to control.

TABLE 15
Effect of the application of Exuroot ™ plus a formulation of Bacillus
and Pseudomonas on nutrient uptake in bell pepper.

| | Nutrient (Kg/Ha) | | | | |
|---|---|---|---|---|---|
| Treatment | N | P | K | Ca | Mg |
| Control | 400 | 31 | 451 | 206 | 56 |
| Treatment | 596 | 42 | 590 | 232 | 59 |

The yield of plants treated according to the invention showed a significant increase. Total fruit yield was 21% higher with the treatment of the invention, and the increase of first quality fruits was 31% as compared to control. See Table 16.

TABLE 16
Yield of first quality bell pepper fruits.

| | Yield (Boxes/Ha) | | | | | |
|---|---|---|---|---|---|---|
| Treatment | E. Large | Large | Medium | Small | Choice | Total |
| Control | 1548 | 1173 | 1253 | 139 | 677 | 4790 |
| Treatment | 1884 | 1686 | 1511 | 117 | 599 | 5797 |

### Example 7

This example used indeterminate tomato plants in a green house. The plants were grown in 7 L pots with an inert substrate. Hydroponic conditions were used with a nutrient supply according to each phenologic stage of the crop. The design of the experiment was simple and complete random with 10 replications and each plant was one experimental unit.

Four treatments were carried as follows:

A. Formulation for root growth stimulation (Exuroot™) at 2 L/Ha

B. Formulation of Bacillus and Pseudomonas (Rhizobac™) root inoculant at 8 L/Ha.

C. Formulation 1 and formulation 2 at 2 and 8 L/Ha respectively.

D. Control

Population samplings were performed at 40, 80, 120 and 160 days, and the counting of colonies was determined by plate counting. The minirhizotron technique was used to measure root development by placing transparent polybutyrate tubes in the root zone of 4 plants per treatment. Sixty images were analyzed per tube at 80 and 160 days after transplanting, the number of active roots was counted, root length and root superficial area were measured. At 80 days of crop development dry weight was measured to determine vegetative growth. At harvest, the number and weight of fruits were measured.

For heterotrophic aerobic bacteria, an increasing tendency for the variables was shown in all treatments with time elapsing; for the treatments with Exuroot™ or Rhizobac™ the populations were higher as compared to control. The simultaneous application of both formulations showed higher results as compared to each one by itself and at 160 days after transplant more than 100% increase was shown as compared to control (Table 17).

TABLE 17
Population dynamics of heterotrophic aerobic
bacteria in tomato rhizosphere

| | CFU/g | | | |
|---|---|---|---|---|
| Treatments | 40 dat | 80 dat | 120 dat | 160 dat |
| Control | 5.5 × 10¹¹ | 2 × 10¹¹ | 2 × 10¹¹ | 1.9 × 10¹² |
| Exuroot ™ | 1.7 × 10¹² | 2 × 10¹² | 2 × 10¹² | 3.9 × 10¹² |
| Rhizobac ™ | 6 × 10¹¹ | 1.8 × 10¹² | 3 × 10¹² | 3.2 × 10¹² |
| Exuroot ™ + | 7.5 × 10¹¹ | 2.6 × 10¹² | 3.6 × 10¹² | 4.7 × 10¹² |
| Rhizobac ™ | | | | |

For Pseudomonas, the tendency of populations was to decrease as time elapsed but the differences between treatments were favorable for Rhizobac™ treatment; at 160 days after transplanting, population for simultaneous application was more than 30 times higher than that of the control (Table 18).

TABLE 18
Population dynamics of Pseudomonas in tomato rhizosphere

| | CFU/g | | | |
|---|---|---|---|---|
| Treatments | 40 dat | 80 dat | 120 dat | 160 dat |
| Control | 1 × 10⁷ | 5 × 10⁶ | 1 × 10⁶ | 1 × 10⁶ |
| Exu-Root | 1 × 10⁷ | 6 × 10⁶ | 5 × 10⁶ | 1 × 10⁶ |
| Rhizobac | 3.7 × 10⁷ | 3 × 10⁷ | 2.3 × 10⁷ | 1.4 × 10⁷ |
| Exu-Root + | 5.2 × 10⁷ | 3.4 × 10⁷ | 3 × 10⁷ | 3.2 × 10⁷ |
| Rhizobac | | | | |

At 80 days after transplanting, all treatments showed higher number, length and area of roots as compared to control. The results for treatments of Exuroot™ or Rhizobac™ alone were equal to each other and lower than the results of the treatment of both formulations together. At 160 days after transplanting, for number of roots, only the treatment of the sum of both formulations showed higher results as compared to control; nevertheless, length and area showed similar results as compared to 80 days after transplanting (Table 19).

TABLE 19
Results for root growth in tomato plants at two sampling times

| | | | Root length | | Root area | |
|---|---|---|---|---|---|---|
| | Number of roots | | (mm/dm² surface) | | (mm²/dm²surface) | |
| Treatment | 80 dat | 160 dat | 80 dat | 160 dat | 80 dat | 160 dat |
| Control | 324 | 1164 | 1696.5 | 4904.7 | 1690.6 | 3425.0 |
| Exuroot ™ | 456 | 1255 | 2311.9 | 6233.6 | 2248.7 | 4636.8 |
| Rhizobac ™ | 393 | 1401 | 2261.9 | 6311.2 | 2302.3 | 4497.5 |
| Exuroot ™ + | 527 | 1667 | 2714.6 | 7615.2 | 2800.6 | 5329.9 |
| Rhizobac ™ | | | | | | |

Biomass production was significantly increased after the application of all treatments and the higher weight was shown for the treatment of Rhizobac™ plus Exuroot™, the root being the most affected organ with more than double the result for dry weight, as compared to control (Table 20).

TABLE 20
Dry matter weight per plan of tomato
at 80 days after transplanting

| | Dry weight (g/plant) | | | | |
|---|---|---|---|---|---|
| Treatment | Root | Stems | Leaves | Fruits | Totals |
| Control | 26.5 | 16.8 | 27.2 | 44.6 | 115.1 |
| Exu-Root | 37.7 | 18.0 | 26.8 | 48.9 | 131.4 |
| Rhizobac | 45.1 | 20.3 | 33.2 | 44.9 | 143.5 |
| Exu-Root + Rhizobac | 58.1 | 33.4 | 23.4 | 52.2 | 167.1 |

The yield in number of fruits, only the treatment with Rhizobac™ plus Exuroot™ showed higher results as compared to control. In the weight of fruits per plant, all treatments were higher than control with Rhizobac™ and Exuroot™ alone being equal to each other but lower than the treatment with their sum. This means that Exuroot™ and Rhizobac™ had a positive effect in fruit size but not in the weight per plant and the treatment of the two materials together positively affected both parameters.

TABLE 21
Yield in fruits per plant

| | | Weight of |
|---|---|---|
| | Number of | fruits per plant |
| Treatment | fruits per plant | (g) |
| Control | 27 | 1722 |
| Exu-Root | 28 | 2908 |
| Rhizobac | 30 | 3043 |
| Exu-Root + | 41 | 4416 |
| Rhizobac | | |

### Example 8

The experiment was carried in tomato plants cv Badro of indeterminate growth, under green house conditions. They were transplanted to 20 L capacity pots with sandy soil inoculated with a suspension of Fusarium oxysporum f sp. lycopersici Race III in a concentration of 8×10⁵ spores per milliliter; 73 mL of the suspension were added to each pot before transplanting. Each treatment consisted of 4 replications with 10 pots per replication, thus with a total of 40 plants per treatment.

The treatments were as follows:

A. Rhizobac-P™ at the rate of 4 L/Ha, and Exuroot™ at the rate of 2 L/ Ha were applied every week beginning at transplanting and a total of 8 applications.

B. Rhizobac-P™ at the rate of 4L/Ha, and Exuroot™ at the rate of 2 L/Ha were applied every week beginning at transplanting and a total of 16 applications.

At 16 weeks after transplanting, highly significant differences were shown for dry weight of the plants. The treatments of Rhizobac™ were equal to each other but higher than the control (Table 22).

TABLE 22
Dry weight of tomato plants

Dry weight per plant (g)

| Treatment | 12 wat | 16 wat |
|---|---|---|
| 1. Control | 30.5 | 109.6 |
| 2. Rhizobac 8 appl. | 31.0 | 161.7 |
| 3. Rhizobac 16 appl. | 30.8 | 160.9 |

wat: weeks after transplanting

Significant differences were shown for incidence of dead plants. The control was the most affected treatment by the disease, with 68% of incidence at 10 weeks after beginning of symptoms. Dead plants began appearing at 2 weeks after the first symptoms. In treatment Rhizobac™, eight applications, dead plants first appeared at 10 weeks after symptoms initiation with a maximum of 35% incidence.

TABLE 23
Incidence of dead tomato plants by Fusarium damage

| Treatment | % of dead plants | | |
|---|---|---|---|
| | 2 wasi | 7 wasi | 10 wasi |
| 1. Control | 4 | 18 | 68 |
| 2. Rhizobac 8 appl. | 0 | 0 | 35 |
| 3. Rhizobac 16 appl. | 0 | 5 | 45 |

wasi = weeks after symptoms initiation

Significant differences were shown for treatments in total yield of first class tomato and in the sizes distribution also. The treatment Rhizobac™, eight applications showed the highest yield and highest contribution of big sizes.

TABLE 24
Yield of first quality tomato

Boxes per hectare

| Treatment | Big | Medium | Small | Total |
|---|---|---|---|---|
| 1. Control | 268 | 1586 | 944 | 2798 |
| 2. Rhizobac ™ | 601 | 2475 | 839 | 3915 |
| 8 appl. | | | | |
| 3. Rhizobac ™ | 512 | 2017 | 487 | 3016 |
| 16 appl. | | | | |

### Example 9

The experiments were run in an experimental field in bell pepper, tomato and corn. A red ferrolitic soil was used. The plots size was 16m² with 1 m separation between plots. Four variables were utilized with 3 replications of each one, with a randomized blocks experimental design. The design was the same for the 3 crops. Only 50% of the nitrogen fertilizer requirement was applied.

Treatments were:

A. Exuroot™,

B. A. chroococcum, and

C. a combination of Exuroot™ and A chroococcum.

The inoculation of A. chroococcum was made by spraying the specific liquid product strain for tomato and pepper with a concentration of 10¹⁰ cells/mL, and a specific liquid product strain for corn. The product quantity for each plot was 50 mL dissolved in 2 L of water; this quantity was applied with a sprayer at planting time. A rate of 5 mL of Exuroot™ was applied. Every 15 days, after 60 days of planting, soil samples were collected from the root zone, to determine A. chroococcum population by plate counting in Ashby culture medium.

As is shown on tables 25-27, approximately at the day 90 after planting, the population of Azotobacter began to decrease as a consequence of the plants aging, they begun to generate less radical secretions poorest in nutritive substances; as a consequence the rhizospheric bacteria, in general, are in a less favorable environment. However, in the treatment using a combination of Azotobacter and Exuroot, the population is about 10 times higher. In this treatment, a reduction also occurs in the population, but always in an about an order of magnitude. The benefits of the Azotobacter activity persist for a longer time, when the soil is treated with Exuroot™.

While not wishing to be bound by theory, it appears that the polyhydroxycarboxylic acid extract in Exuroot™ appears to play a role in enhancing the photosynthetic efficiency of the plants; this leads to better contents of carbohydrates and organic acids in the radical secretions that benefit the multiplication of bacteria and also induces metabolic changes in the plants that determine a higher carbohydrate content.

The application of Exuroot™ helps in the establishment and multiplication of Azotobacter chroococcum in the rhizosphere of the plants. The data indicates that this conditioning allows for the growth of a larger population of the bacteria for a longer time so the plants can take advantage more intensively of the bacterial benefits. Such extended populations result in a higher free nitrogen supply by means of the atmospheric nitrogen fixation and more vigorous plants thereby attaining a shorter crop cycle and enhancing the crop yield by the action of active substances synthesized by the bacteria.

TABLE 25
Population of A. chroococcum in bell pepper rhizosphere

| | Azotobacter population (CFU/g soil) | | | | |
|---|---|---|---|---|---|
| Treatments | 60 dap | 75 dap | 90 dap | 105 dap | 120 dap |
| Control | 6 × 10³ | 5 × 10⁴ | 7 × 10⁴ | 3 × 10⁴ | 3 × 10⁴ |
| Exuroot ™ | 9 × 10³ | 5 × 10⁴ | 6 × 10⁴ | 9 × 10⁴ | 5 × 10⁴ |
| Azotobacter | 5 × 10⁷ | 5 × 10⁸ | 6 × 10⁷ | 3 × 10⁷ | 4 × 10⁶ |
| Azotobacter + | 7.5 × 10⁸ | 4 × 10⁹ | 2 × 10⁹ | 8.5 × 10⁸ | 6.5 × 10⁷ |
| Exuroot ™ | | | | | |

dap = days after planting

TABLE 26
Population of A. chroococcum in tomato rhizosphere

| | Azotobacter population (CFU/g soil) | | | | |
|---|---|---|---|---|---|
| Treatments | 60 dap | 75 dap | 90 dap | 105 dap | 120 dap |
| Control | 6 × 10³ | 5 × 10⁴ | 5 × 10⁴ | 5.5 × 10⁴ | 4 × 10⁴ |
| EXU ROOT | 5 × 10³ | 7 × 10⁴ | 5 × 10⁴ | 3 × 10⁴ | 5 × 10⁴ |
| Azotobacter | 8 × 10⁷ | 2.5 × 10⁸ | 8 × 10⁸ | 7 × 10⁷ | 6 × 10⁶ |
| Azotob + EXU ROOT | 6 × 10⁸ | 2.5 × 10⁹ | 6 × 10⁹ | 8 × 10⁸ | 5 × 10⁷ |

TABLE 27
Population of A. chroococcum in corn rhizosphere

| | Azotobacter population (CFU/g soil) | | | | |
|---|---|---|---|---|---|
| Treatment | 60 dap | 75 dap | 90 dap | 105 dap | 120 dap |
| Control | 5 × 10³ | 5 × 10⁴ | 5 × 10⁴ | 6 × 10⁴ | 8 × 10⁴ |
| Exuroot ™ | 4.5 × 10³ | 6 × 10⁴ | 5 × 10⁴ | 5.5 × 10⁴ | 8 × 10⁴ |
| Azotobacter | 2 × 10⁸ | 3.5 × 10⁸ | 6 × 10⁷ | 5 × 10⁷ | 3.5 × 10⁶ |
| Azotobacter + | 5.5 × 10⁹ | 4 × 10⁹ | 8 × 10⁸ | 3 × 10⁸ | 8 × 10⁷ |
| Exuroot ™ | | | | | |

### Example 10

The experiment was carried in broccoli in a sandy soil, slightly alkaline. Fertilization was made with compost at a dose of 20 ton/Ha and transplantation was made to sowing beds 1.2×10 meter per treatment per replication. The applications were made every two weeks beginning at transplanting. The experimental design was random blocks with 4 replications. Evaluations were made of plant height, stems diameter before harvest and yield of three cuttings.

Two treatments were used:

A. Azotobacter formulation (1×10⁹ CFU/mL) for four applications of 10 L/Ha for each.

B. Azotobacter+Exuroot™ formulations for four applications of 10+2 L/Ha each, respectively.

Significant differences were shown for the three variables. All treatments were higher than the control, but the mixture containing Azotobacter and Exuroot™was better than the treatment of Azotobacter alone (Table 28).

TABLE 28
Height, stems diameter and yield of broccoli

| | Variables | | |
|---|---|---|---|
| | | Stems | |
| | Plant height | diameter | Yield |
| Treatment | (cm) | (mm) | (Kg/plot) |
| Control | 39.9 | 37.5 | 12.7 |
| Azotobacter | 40.4 | 39.1 | 15.9 |
| Azotobacter + | 45.3 | 41.2 | 17.8 |
| Exuroot ™ | | | |

What is claimed is:

1. A method for enhancing plant productivity and health by a treatment process including: (a) physiologically conditioning plant roots with a root conditioning agent, and (b) inoculating the treated roots with a microbiologic formulation comprising beneficial microorganisms in an inactive or active colony form.

2. A method according to claim 1 wherein said root conditioning agent comprises an organic compound that enhances root growth.

3. A method according to claim 2 wherein said root conditioning agent comprises a polyhydroxycarboxylic acid, a hydroxybenzoic acid, a combination of at least one polyhydroxycarboxylic acid and at least one hydroxybenzoic acid; vitamins; sugars; polyols; organic aliphatic acids; organic aromatic acids; ligno-derivatives; flavones, flavanones and isoflavones; lipids; carotinoids; puric and pirimidic bases; phyto-hormones; giberelines; cytokinins; humic acids; fulvic acids; humines; or other plant growth hormones.

4. A method according to claim 3 wherein said root conditioning agent comprises a polyhydroxycarboxylic acid, a hydroxybenzoic acid, combinations of polyhydroxycarboxylic acids and hydroxybenzoic acids.

5. A method according to claim 1 wherein said colony of beneficial microorganisms comprises at least one species selected from the group consisting of plant growth promoting rhizobacteria, Pseudomonas sp., Bacillus sp., Azotobacter sp., Azospirillum sp., Rhizobium sp., Bradyrhizobium sp., Agrobacterium sp., Enterobacter sp., Paenibacillus sp., Burkholderia sp., Methylobacter sp., Pantoea sp., Pasteuria sp., Anabaena sp., Nostoc sp., and a beneficial fungus.

6. A method according to claim 5 wherein said colony of beneficial microorganisms comprises a beneficial fungus is selected from the group consisting of Trichoderma, vesicular arbuscular mycorrhizal.

7. A method according to claim 5 wherein said colony of beneficial microorganisms comprises Actinomycete: Streptomyces sp., Micromonospora sp., Streptosporangium sp., Actinomadura sp., Microtetrasporas sp., Nocardia sp., Saccharopolyspora sp., Streptoverticillium sp., Microbispora sp., Microtetraspora sp., Actinobispora sp., Thermoactinomyces sp., Actinoplanes sp., and Gordonia sp.

8. A method according to claim 1 wherein said conditioning agent is applied at a concentration within the range of 10⁻¹⁰ to 10⁻² M.

9. A method according to claim 1 wherein said microbiologic formulation is dry and comprises a concentration of said beneficial microorganisms that is within the range of 10²-10¹² CFU/g.

10. A method according to claim 1 wherein said microbiologic formulation is an aqueous solution and comprises a concentration of said beneficial microorganisms that is within the range of 10²-10¹² CFU/ml.

11. A method according to claim 1 wherein said plant roots are associated with a grain crop, a crop that grows fruiting sites, a vegetable, a grass, a flowering plant, a tree, a shrub, an ornamental plant, or an industrial crop.

12. A method according to claim 11 wherein said plant roots are associated with an industrial crop selected from the group consisting of forage, cotton, sugar cane, tobacco, agave, alfalfa, and clover.
